(19) United States
(12) Patent Application Publication
(10) Pub. No.: US 2020/0280335 A1
(43) Pub. Date: Sep. 3, 2020

(54) A POLARIZED ANTENNA BASED FULL DUPLEX RADIO FRONT-END USING ELECTRICAL BALANCE

(71) Applicant: INDIAN INSTITUTE OF TECHNOLOGY MADRAS (IIT MADRAS), Chennai (IN)

(72) Inventors: Kumar ABHISHEK, Chennai (IN); Aniruddhan SANKARAN, Chennai (IN); Ganti RADHAKRISHNA, Chennai (IN)

(73) Assignee: INDIAN INSTITUTE OF TECHNOLOGY MADRAS (IIT MADRAS), Chennai (IN)

(21) Appl. No.: 16/649,266

(22) PCT Filed: Sep. 17, 2018
(86) PCT No.: PCT/IN2018/050601

§ 371 Date: Mar. 20, 2020

(30) Foreign Application Priority Data
Sep. 20, 2017 (IN) 201741033284

(51) Int. Cl. H04B 1/525; H04L 5/14

(52) U.S. Cl. CPC H04B 1/525; H04L 5/1461

(57) ABSTRACT

The present invention relates to an electrical balance based on a fullduplex radio front-end employs dual polarized antennas for isolating wideband range between transmitter and receiver path, wherein the polarized antennas are connected to coupled ports of duplexer with respect to transmitter port (Tx) for simultaneous transmission and reception while isolating transmitter and receiver of the same node.

### FIELD OF THE INVENTION

The present invention relates to the wideband isolation between transmitter and receiver for full duplex communication. More specifically relates to a polarized antenna based RF front end using electrical balance for suppressing self interference by transmitting signal and for wideband isolation.

### BACKGROUND OF THE INVENTION

Same channel full duplex communication allows a device to transmit and receive at the same time and same frequency. Major challenge in implementing such system is handling of self interference by transmitting signal. Since we know the transmitting signal, theoretically it can be cancelled in the receiver. But the orders of magnitude difference in the strength of transmitting signal and receiving signal make the cancellation difficult.

The objective of the present invention is to provide a RF front-end employing two polarized antennas to achieve isolation between transmitter and receiver for full duplex communication.

### SUMMARY OF THE INVENTION

The present invention relates to the wideband isolation between transmitter and receiver for full duplex communication. More specifically relates to a polarized antenna based RF front end using electrical balance for suppressing self interference to manageable limit in wide frequency range without causing any loss in transmitter and receiver path wideband isolation.

In one embodiment, the present invention provides an electrical balance based duplexer for wideband isolation between two ports. Two polarized antennas oriented perpendicular to each other are connected to coupled ports of duplexer when looking from transmitter port. Pair of such nodes when oriented properly allows simultaneous transmission and reception while isolating transmitter and receiver of the same node.

### BRIEF DESCRIPTION OF THE DRAWINGS

FIG. 1 shows full duplex front-end using electrical balance based directional coupler.

FIG. 2 shows two identical nodes oriented 90° facing each other.

FIG. 3 shows using vector modulator to cancel residual Tx leakage.

FIG. 4 shows using mixer as vector modulator to cancel residual Tx leakage.

FIG. 5 shows using tuning network to cancel residual Tx leakage.

Referring to the drawings, the embodiments of the present invention are further described. The figures are not necessarily drawn to scale, and in some instances the drawings have been exaggerated or simplified for illustrative purposes only. One of ordinary skill in the art may appreciate the many possible applications and variations of the present invention based on the following examples of possible embodiments of the present invention.

### DETAILED DESCRIPTION OF THE INVENTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The present invention relates to the wideband isolation between transmitter and receiver for full duplex communication. More specifically relates to a polarized antenna based RF front end using electrical balance for suppressing self interference to manageable limit in wide frequency range without causing any loss in transmitter and receiver path wideband isolation.

The present invention provides an electrical balance based duplexer for wideband isolation between two ports. Two polarized antennas oriented perpendicular to each other are connected to coupled ports of duplexer when looking from transmitter port. Pair of such nodes when oriented properly allows simultaneous transmission and reception while isolating transmitter and receiver of the same node.

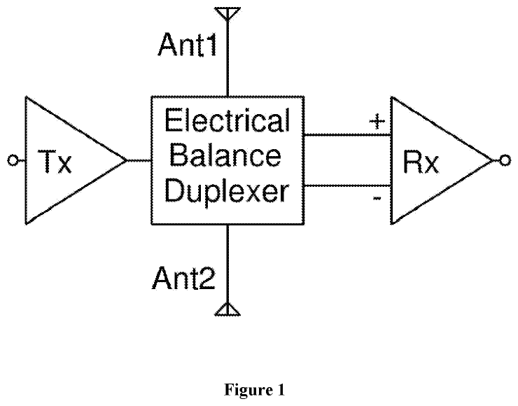

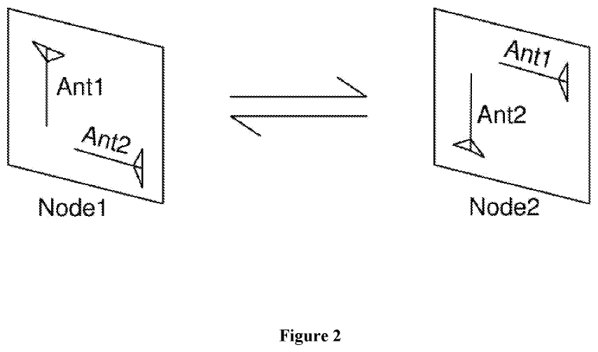

FIG. 1 show polarized antennas (Ant1, Ant2) are oriented perpendicular to each other and connected with coupled ports of duplexer w.r.t. transmitter port (Tx). In transmission mode, all the transmitted power is radiated by the two antennas. The two antennas being identical result in equal impedance at the coupled ports allowing wideband isolation between transmitter and receiver (Rx) ports. Pair of identical nodes are used for full duplex communication. But they have to be oriented 90° facing each other as shown in FIG. 2. In this arrangement, signal received by the two antennas of a node are out of phase with each other resulting in constructive addition at Rx port.

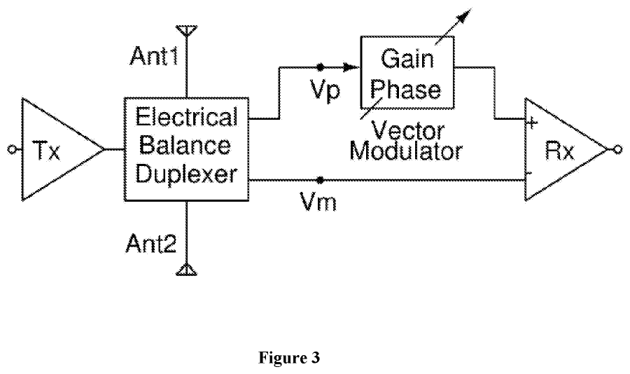

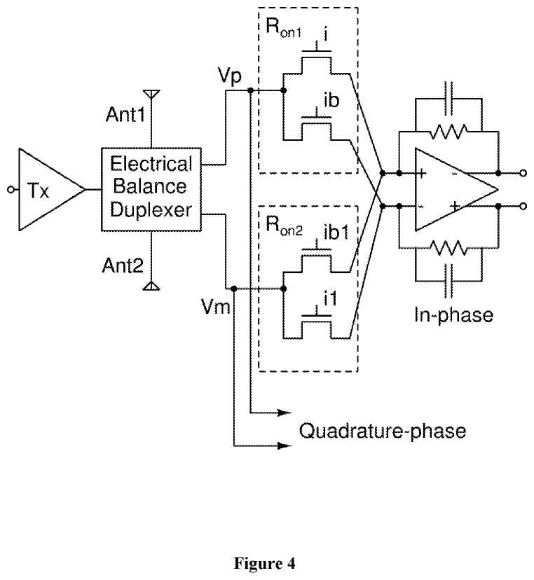

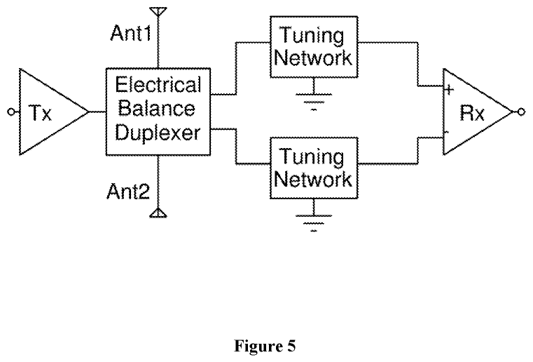

For all practical designs, there is finite common-mode isolation between Tx and Rx ports. Also mismatch between Ant1 and Ant2 give rise to Tx signal at Rx port. Usually strength of common-mode Tx signal is much higher than differential-mode Tx signal at Rx port. Tx signal can be completely cancelled at Rx port by adjusting gain and phase of single-ended voltage at the two terminals of Rx port before subtracting them as shown in FIG. 3. This may cause loss of some received signal in reception mode. As long as common-mode signal is higher than differential-mode signal, signal received by the antenna will not get completely cancelled at Rx port. Vector modulator can be realized as a part of receiver mixer. The phase shift can be achieved by shifting LO of Vm path (i1, ib1) w.r.t. Vp path (i, ib). Variable gain can be implemented by varying switch resistance (Ron1, Ron2) of mixer as shown in FIG. 4. Another approach is to add tuning networks in duplexer Rx port before receiver as shown in FIG. 5. Tuning networks convert leaked differential Tx signal into common-mode, which can be rejected by receiver. Any one of the tuning networks or both can be used.

It may be appreciated by those skilled in the art that the drawings, examples and detailed description herein are to be regarded in an illustrative rather than a restrictive manner.

We claim:

1. An electrical balance based full duplex radio front-end employs dual polarized antennas for isolating wideband range between transmitter and receiver path, wherein the polarized antennas are connected to coupled ports of duplexer with respect to transmitter port (Tx) for simultaneous transmission and reception while isolating transmitter and receiver of the same node.

2. The electrical balance based full duplex radio front-end as claimed in claim 1, wherein the polarized antennas are oriented perpendicular to each other.

3. The electrical balance based full duplex radio front-end as claimed in claim 1, wherein the polarized antenna based RF front end suppresses self interference in wide frequency range without any loss in transmitter and receiver path.

4. The electrical balance based full duplex radio front-end as claimed in claim 1, wherein common-mode coupling is used to cancel Tx leakage signal.

5. The electrical balance based full duplex radio front-end as claimed in claim 4, wherein mixer circuit is used as vector modulator of common-mode Tx signal to cancel Tx leakage signal and down convert Rx signal simultaneously

6. The electrical balance based full duplex radio front-end as claimed in claim 4, wherein impedance tuning of common-mode Tx signal is used to cancel Tx leakage signal.
